(19) United States
(12) Patent Application Publication
(10) Pub. No.: US 2026/0134336 A1
(43) Pub. Date: May 14, 2026

(54) ARTIFICIAL INTELLIGENCE CONTENT GENERATION BASED ON USER DATA COMMUNICATIONS

(71) Applicant: T-MOBILE INNOVATIONS LLC, Overland Park, KS (US)

(72) Inventor: Ming Shan Kwok, Seattle, WA (US)

(21) Appl. No.: 18/944,414

(22) Filed: Nov. 12, 2024

(51) Int. Cl. G06N 20/00

(52) U.S. Cl. CPC G06N 20/00

(57) ABSTRACT

A user communication device exchanges user data with data communication equipment. In response to exchanging the user data, the user communication device trains a user Artificial Intelligence (AI) model with the user data. The user communication device transfers a query to the user AI model, and in response, receives user context from the user AI model. The user communication device transfers a prompt that includes the user context to a generative AI model. In response, the user communication device receives AI content from the generative AI model that is based on the user context.

### TECHNICAL BACKGROUND

Data communication systems provide data services to user communication devices like phones, computers, vehicles, and other user systems. The data services may include internet-access, user messaging, voice/video calling, machine control, or some other data communication product. The data communication systems may feature wireless communication networks. The wireless communication networks comprise wireless access nodes like Wireless Fidelity (WIFI) hotspots, Fifth Generation New Radio (5GNR) cell towers, and satellites in earth orbit. The wireless communication networks further comprise network elements that exchange user data with the user communication devices over the wireless access nodes.

Artificial Intelligence (AI) models comprise processing nodes that are interconnected by edges to form neural networks. The AI models receive prompts from users. The AI models process the prompts through the nodes and edges of their neural networks to generate AI content for the users. The AI models are trained by pre-processing training data. Large Language Models (LLMs) are trained with vast quantities of available training data, and the LLMs can handle natural language prompts. The AI models can generate rich user content like videos, reports, lists, and the like. Although, the LLMs are aware of individual users and their user information, the user information may not be properly weighted by the LLMs. As a result, the AI content from the LLMs may not be adequately personalized for the user.

### TECHNICAL OVERVIEW

In some examples, a data communication device comprises a data communication interface and a data processing system. The data processing system executes a user AI model and a generative AI model. The data processing system exchanges user data with a data communication interface. The data communication interface exchanges the user data with a data communication network. The data processing system trains the user AI model with the user data in response to exchanging the user data. The data processing system transfers a query to the user AI model, and in response, receives user context from the user AI model. The data processing system transfers a prompt that includes the user context to the generative AI model. In response, the data processing system receives AI content from the generative AI model that is based on the user context.

In some examples, a method comprises the following operations. Exchange user data with data communication equipment. In response to exchanging the user data, train a user AI model with the user data. Transfer a query to the user AI model, and in response, receive user context from the user AI model. Transfer a prompt that includes the user context to a generative AI model, and in response, receive AI content from the generative AI model that is based on the user context.

In some examples, a method comprises the following operations. Wirelessly exchange user data with one or more wireless communication systems. In response to wirelessly exchanging the user data, label the user data and train an Artificial Intelligence (AI) Large Language Model (LLM) with the labeled user data. Transfer a prompt that includes a user query to the AI LLM. The AI LLM processes the user query to generate user context and processes the prompt with the user context to generate AI content. Receive the AI content from the AI LLM.

### DESCRIPTION OF THE DRAWINGS

FIG. 1 illustrates an exemplary user communication device to generate Artificial Intelligence (AI) content for a user based on their user data communications.

FIG. 2 illustrates an exemplary operation of the user communication device to generate AI content for the user based on their user data communications by using two AI models.

FIG. 3 illustrates the exemplary operation of the user communication device to generate the AI content for the user based on their user data communications by using the two AI models.

FIG. 4 illustrates an exemplary operation of the user communication device to generate the AI content for the user based on their user data communications by using one AI model.

FIG. 5 illustrates the exemplary operation of the user communication device to generate the AI content for the user based on their user data communications by using the one AI model.

FIG. 6 illustrates an exemplary operation of the user communication device to generate the AI content for the user based on their user data communications by using one AI model and a user information system.

FIG. 7 illustrates the exemplary operation of the user communication device to generate the AI content for the user based on their user data communications by using the one AI model and the user information system.

FIG. 8 illustrates exemplary processing circuitry to generate AI content for a user based on their user data communications.

FIG. 9 illustrates an exemplary wireless User Equipment (UE) that generates AI content based on use of the wireless UE.

FIG. 10 illustrates an exemplary software architecture for the wireless UE that generates AI content based on use of the wireless UE.

FIG. 11 illustrates an exemplary operation of the wireless UE to generate AI content by using a UE model and a network model.

FIG. 12 illustrates an exemplary operation of the wireless UE to generate AI content by using a network model.

FIG. 13 illustrates an exemplary operation of the wireless UE to generate AI content by using a network model and a user information system.

FIG. 14 illustrates an exemplary vehicle that generates AI content based on vehicle data communications.

### DETAILED DESCRIPTION

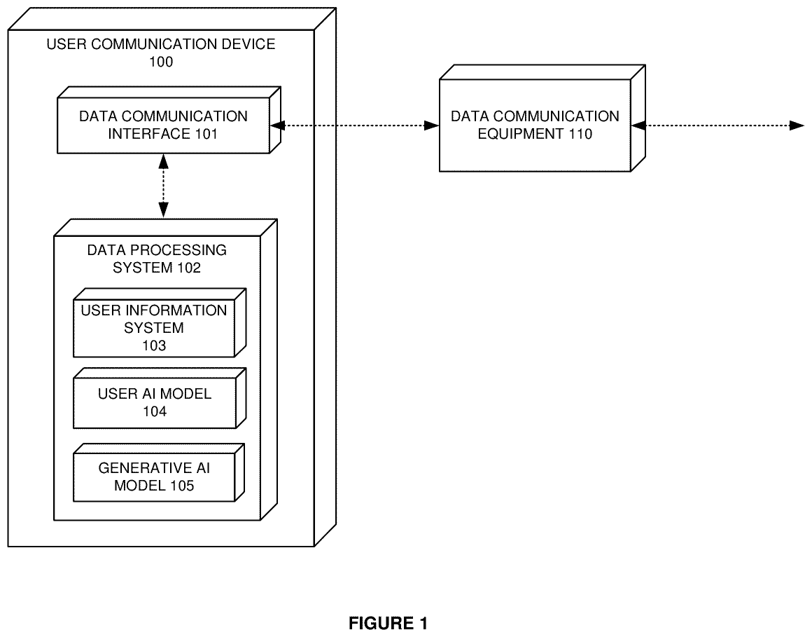

FIG. 1 illustrates exemplary user communication device 100 to generate Artificial Intelligence (AI) content for a user based on their user data communications. The AI content comprises media, software, reports, instructions, and/or some other user information. User communication device 100 could be a phone, computer, vehicle, and/or some other user apparatus with data communication components. User communication device 100 comprises data communication interface 101 and data processing system 102. Data communication interface 101 communicates with data processing system 102 and data communication equipment 110. Data processing system 102 comprises user information system 103, user AI model 104, and generative AI model 105. Data communication equipment 110 comprises access nodes, routers, and/or some other data communication apparatus. Data communication interface 101 and data communication equipment 110 may comprise radios to exchange wireless data communications.

Data communication interface 101 comprises transmitters, receivers, controllers, and/or some other communication components. Data processing system 102 comprises computer circuitry and software and/or some other electronics. User information system 103 comprises a data structure that associates a user with user information like identity, demographics, favorites, employment, friends, relatives, activities, travels, data communication characteristics, and the like. User AI model 104 may comprise nodes and edges that form a neural network to generate user context—which is typically detailed information about the user. Generative AI model 105 may comprise nodes and edges that form a neural network to generate AI content based on prompts and the user context. AI models 104-105 may comprise Large Language Models (LLMs).

In some examples, data processing system 102 executes user AI model 104 and generative AI model 105. Data processing system 102 exchanges user data with data communication interface 101. Data communication interface 101 exchanges the user data with data communication equipment 110. The user data comprises location data, audio data, video data, image data, user messaging data, user application data, content-streaming data, social networking data, and/or some other user-related information. Data processing system 102 trains user AI model 104 with the user data in response to the user data exchange—although some sensitive user data may be filtered from the training data. Data processing system 102 may train user AI model 104 with user information like user identity, demographics, applications, pictures, favorites, employment, friends, relatives, activities, travels, communication characteristics, device usage, and the like. Data processing system 102 transfers a query to user AI model 104. User AI model 104 processes the query to generate and transfer user context to data processing system 102. Data processing system 102 receives the user context from user AI model 104. Data processing system 102 transfers a prompt that includes the user context to generative AI model 105. Generative AI model 105 processes the prompt to generate and transfer AI content to data processing system 102. Data processing system 102 receives the AI content from generative AI model 105. The AI content is personalized for the user based on the user context from user AI model 104. For example, the AI content may be an AI-generated image of the user and a friend at a favorite restaurant along with a dinner invitation to the restaurant.

In some examples, data processing system 101 determines labels for portions of the user data. The labels describe the user data like a name for a person in a photograph or a location of a home residence. Data processing system 101 then trains user AI model 104 with the labeled user data. Data processing system 102 may prompt a user to label portions of the user data, and receive the labels for the user data from the user. Data processing system 102 may label a recent portion of the user data in response to a past portion of the user data. For example, data processing system 102 may process past photographs of a sports team to determine that a recent photograph has a player from that team. Data processing system 102 may process past photographs to determine that a recent photograph has an unidentified person and prompt the user to identify the unidentified person.

In some examples, user communication device 101 is integrated into a machine like a vehicle, robot, computer, and/or some other intelligent apparatus. In these examples, the machine is the user as opposed to a person, and the user data comprises machine data. Thus, user AI model 104 comprises a machine AI model that is trained with machine data communications. The resulting AI content comprises machine content that is customized for the machine by the machine context.

In some examples, data communication interface 102 receives updates over data communication equipment 110 for user AI model 104 and/or generative AI model 105. In response, data processing system 102 updates user AI model 104 and/or generative AI model 105. AI software for labeling, training, querying, and prompting may also be updated.

With respect to the user information from user information system 103 that is used for training, the user identity comprises names, addresses, images, and/or some other user indicators. The demographics comprises age, residence, employment, and/or some other personal characteristics. The applications comprise software products, websites, and the like that are used. The pictures comprise images, videos, animations, and/or some other graphics. The favorites comprise user selections, preferences, usage, and the like. The employment comprises a work history and associated work data. The friends and relatives indicate family and social relationships. The activities indicate hobbies, regimens, habits and/or some other user behaviors. The travels indicate vacations, commutes, residences and offices, and/or some other geographic information. The communication characteristics comprise network access types, network coverage statistics, average uplink throughput and latency, average downlink throughput and latency, network slices, and/or some other network performance information. The device usage indicates when the user is looking at user communication device 100, device orientation and placement, applications used, sensor readings (like weather, video, and audio), and/or some other usage data for user communication device 100.

With respect to the user data communications that are used for training, the location data comprises geographic information for the user like travel routes and favorite places. The audio data comprises voice/video communications, voice memos, music, and/or some other sounds. The video data comprises content like video conferences, movies and shows, video clips, animation, and live video. The image data comprises photographs, animations, QR codes, and/or some other graphics. The user messaging data comprises texts, emails, and/or some other user-to-user data communications. The user application data comprises application identifiers, application types, application data, and/or some other application information. The content-streaming data comprises media and media descriptions for music, movies, sports, podcasts, and the like. The social networking data comprises social network identifiers, social network types, and data that is generated or consumed by the social networks.

The query comprises user information like user identity, interests, activities, locations, or other user characteristics that are used to obtain the user context. The AI prompt comprises a request for desired AI content. The AI content could be media, software, data files, entertainment, or some other AI-generated information. The prompt includes the user context to personalize the generation of the AI content for the user. For example, a query may indicate the user and bicycling. This query yields user context like bicycling friends, routes, equipment, achievements, and the like. The prompt may request an image of the user's bicycling group and include the user context. The resulting AI content may be an AI-generated photograph of the user and their bicycling friends on a favorite mountain trail ten years ago. The AI content is guided by the user context to better personalize the AI content for the user.

In another example, the user is a vehicle and user communication device 100 is integrated into the vehicle. The query indicates the vehicle and maintenance. The query is used to obtain the user context that identifies the vehicle hardware, software, cargo, distance traveled, and places visited. The prompt includes the user context and comprises a request to generate a software update for the vehicle. The AI content comprises the requested software update that is customized for the vehicle hardware and software. The AI content is also configured for the cargo, distances travelled, and places visited by the vehicle.

Data communication interface 101 and data communication equipment 110 may wirelessly communicate using wireless protocols like Wireless Fidelity (WIFI), Fifth Generation New Radio (5GNR), satellite data communications, Long Term Evolution (LTE), Low-Power Wide Area Network (LP-WAN), Near-Field Communications (NFC), Code Division Multiple Access (CDMA), Frequency Division Multiple Access (FDMA), Time Division Multiple Access (TDMA), and/or some other wireless protocol. User communication device 100 and data communication equipment 110 comprise microprocessors, software, memories, transceivers, bus circuitry, and/or some other data processing components. The microprocessors comprise Digital Signal Processors (DSP), Central Processing Units (CPU), Graphical Processing Units (GPU), Application-Specific Integrated Circuits (ASIC), and/or some other data processing hardware. The memories comprise Random Access Memory (RAM), flash circuitry, disk drives, and/or some other type of data storage. The memories store software like operating systems, utilities, protocols, applications, and functions. The microprocessors retrieve the software from the memories and execute the software to drive the operation of user communication device 100 and data communication equipment 110 as described herein.

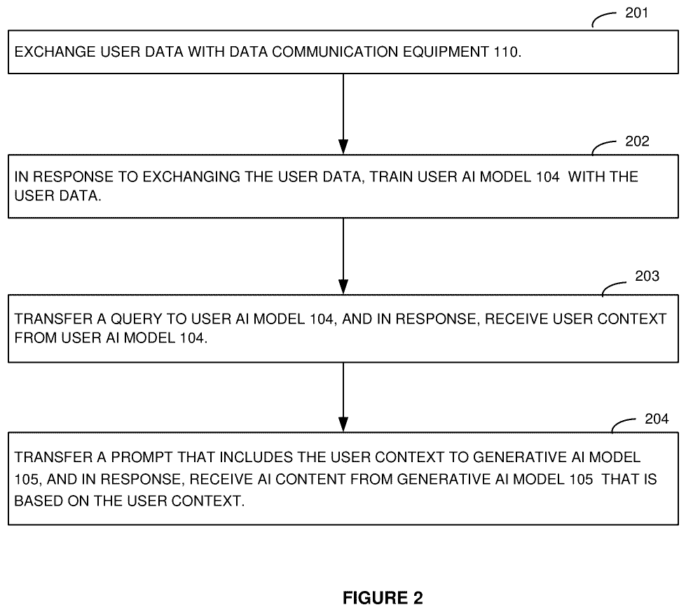

FIG. 2 illustrates an exemplary operation of user communication device 100 to generate AI content for the user based on their user data communications by using user AI model 104 and generative AI model 105. The operation may differ in other examples. User communication device 100 exchanges user data with data communication equipment 110 (201). The user data comprises location data, audio data, video data, image data, user messaging data, user application data, content-streaming data, social networking data, and/or some other user-related information. For a machine, the user data may comprise machine data communications that includes machine-related information. User communication device 100 trains user AI model 104 with the user data in response to the user data exchange (201). Private user data may be removed from this training data. User communication device 100 may train user AI model 104 with other user information as well. User communication device 100 transfers a query to user AI model 104 (203). User AI model 104 processes the query to generate and transfer user context to data processing system 102 (203). Data processing system 102 receives the user context from user AI model 104. Data processing system 102 transfers a prompt that includes the user context to generative AI model 105 (204). Generative AI model 105 processes the prompt based on the user context to generate and transfer AI content to user communication device 100. User communication device 100 receives the AI content from generative AI model 105, and the AI content is based on the user context (204).

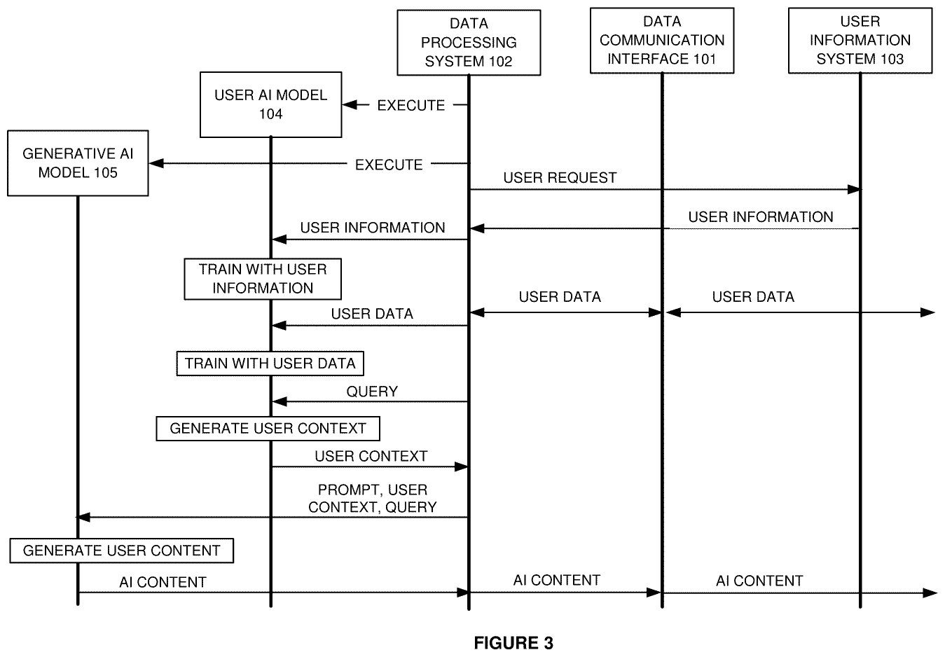

FIG. 3 illustrates the exemplary operation of user communication device 100 to generate the AI content for the user based on their user data communications by using user AI model 104 and generative AI model 105. The operation may differ in other examples. Data processing system 102 executes user AI model 104 and generative AI model 105. Data processing system 102 requests user information from user information system 103. User information system 103 transfers user information to data processing system 102. The user information comprises historical network usage/status, device usage/status, demographics, locations, audios, videos, images, messaging, user applications, content-streaming, social networking, and/or some other user-related information. Data processing system 102 trains user AI model 104 with the user information. For example, user AI model 104 may be trained with past satellite communication performance in association with time, application, and location.

Data processing system 102 exchanges user data over data communication interface 101. The user data comprises location data, audio data, video data, image data, user messaging data, user application data, content-streaming data, social networking data, and/or some other user-related information. For a machine, the user data may comprise machine data communications that includes machine-related information. Data processing system 102 trains user AI model 104 with the user data in response to the user data exchange—although some private user data may be omitted from the training set. Data processing system 102 may train user AI model 104 with other user information as well like recent places visited, photographs taken, user applications executed, and video games played.

Data processing system 102 transfers a query to user AI model 104. The query identifies the user and possibly an area of interest like music. User AI model 104 processes the query to generate and transfer user context to data processing system 102. The user context might indicate songs and artists liked by the user and associated with day, time, location, and other factors. Data processing system 102 receives the user context from user AI model 104. Data processing system 102 transfers a prompt that includes the user context and query to generative AI model 105. The prompt may comprise a request to provide a soundtrack for a vacation. Generative AI model 105 processes the prompt based on the user context and query to generate and transfer AI content to data processing system 102. The AI content is based on the user context. The AI content could be the soundtrack for the vacation that more heavily weighs the songs and artists liked by the user when taking similar vacations. Data processing system 102 transfers the AI content over data communication interface 101.

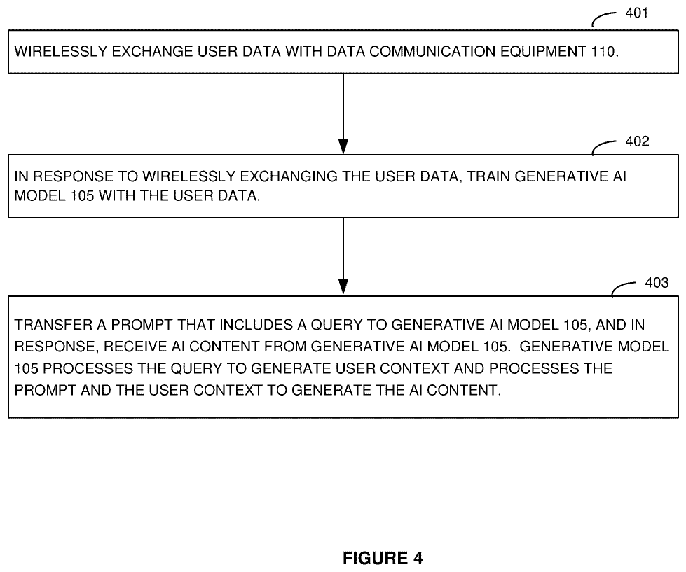

FIG. 4 illustrates an exemplary operation of user communication device 100 to generate the AI content for the user based on their user data communications by using generative AI model 105. User AI model 104 is not used in this example, and the operation may differ in other examples. User communication device 100 wirelessly exchanges user data with data communication equipment 110 (401). User communication device 100 trains generative AI model 105 with the user data in response to the wireless data exchange (402). Sensitive user information may be removed from the training data. User communication device 100 may train generative AI model 105 with other user information as well. User communication device 100 transfers a prompt that includes a query to generative AI model 105 (403). Generative AI model 104 processes the query to generate user context. Generative AI model 105 processes the prompt and the user context to generate AI content based on the user context (403). For example, generative AI model 105 may generate a software module to control a machine.

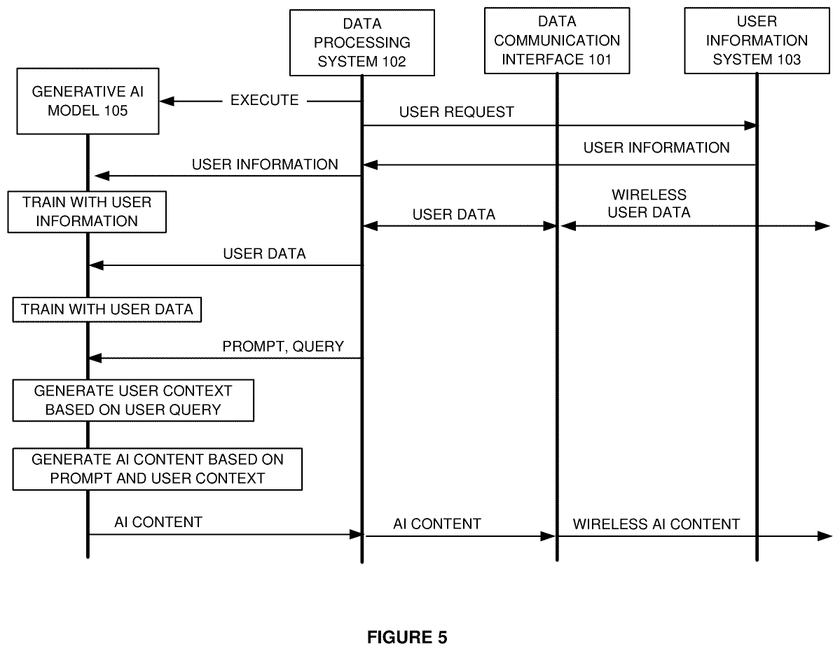

FIG. 5 illustrates the exemplary operation of user communication device 100 to generate the AI content for the user based on their user data communications by using by using generative AI model 105. The operation may differ in other examples. Data processing system 102 executes generative AI model 105. Data processing system 102 requests user information from user information system 103. User information system 103 transfers user information to data processing system 102. The user information comprises past network usage/status, device usage/status, locations, audios, videos, images, messaging, applications, content-streaming, social networking, and/or some other user-related information. Data processing system 102 trains generative AI model 105 with the user information. For example, generative AI model 105 could be trained with weather information sensed by user communication device 100 in association with the time and location.

Data processing system 102 exchanges user data with data communication interface 101. Data communication interface 101 wirelessly exchanges the user data. The user data comprises location data, audio data, video data, image data, user messaging data, user application data, content-streaming data, social networking data, and/or some other user-related information. For a machine, the user data may comprise machine data communications that includes machine-related information. Private user data may be removed from the training data. Data processing system 102 trains generative AI model 105 with the user data in response to the wireless data exchange. Data processing system 102 may train generative AI model 105 with other user information as well.

Data processing system 102 transfers a prompt that includes a query to generative AI model 105. Generative AI model 105 processes the query to generate user context. Generative AI model 105 processes the prompt based on the user context to generate and transfer AI content to data processing system 102. The AI content is based on the user context. Data processing system 102 transfers the AI content to data communication interface 101. Data communication interface wirelessly transfers the AI content.

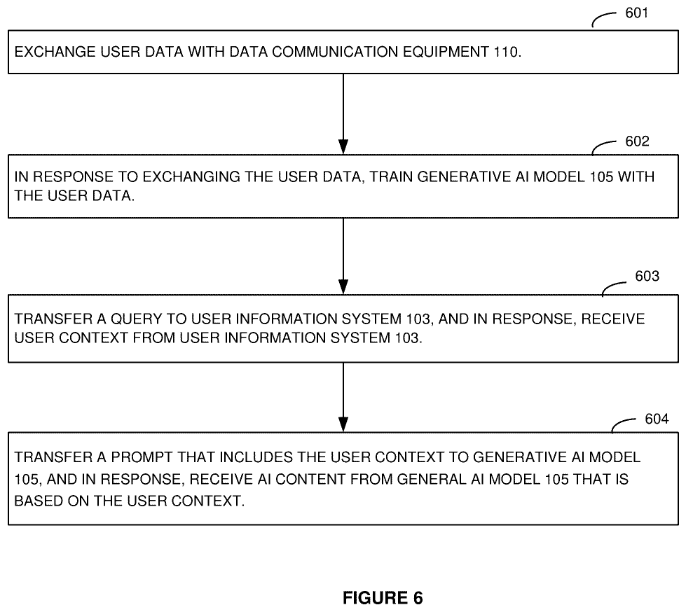

FIG. 6 illustrates an exemplary operation of user communication device 100 to generate the AI content for the user based on their user data communications by using generative AI model 105 and user information system 103. User AI model 104 is not used in this example, and the operation may differ in other examples. User communication device 100 exchanges user data with data communication equipment 110 (601). User communication device 100 trains generative AI model 105 with the user data in response to the user data exchange (602). Sensitive user data may be removed from the training data, and user communication device 100 may train generative AI model 105 with other user information as well. For example, generative AI model 105 may be trained with past locations that had poor wireless network coverage or that had good satellite data communications. User communication device 100 transfers a query to user information system 103 (603). User information system 103 processes the query to generate and transfer user context to data processing system 102. Data processing system 102 receives the user context from user information system 103 (603). Data processing system 102 transfers a prompt that includes the user context to generative AI model 105 (604). Generative AI model 105 processes the prompt based on the user context to generate AI content that is based on the user context (604). For example, the AI content may comprise a prioritized and scheduled list of work tasks for the user.

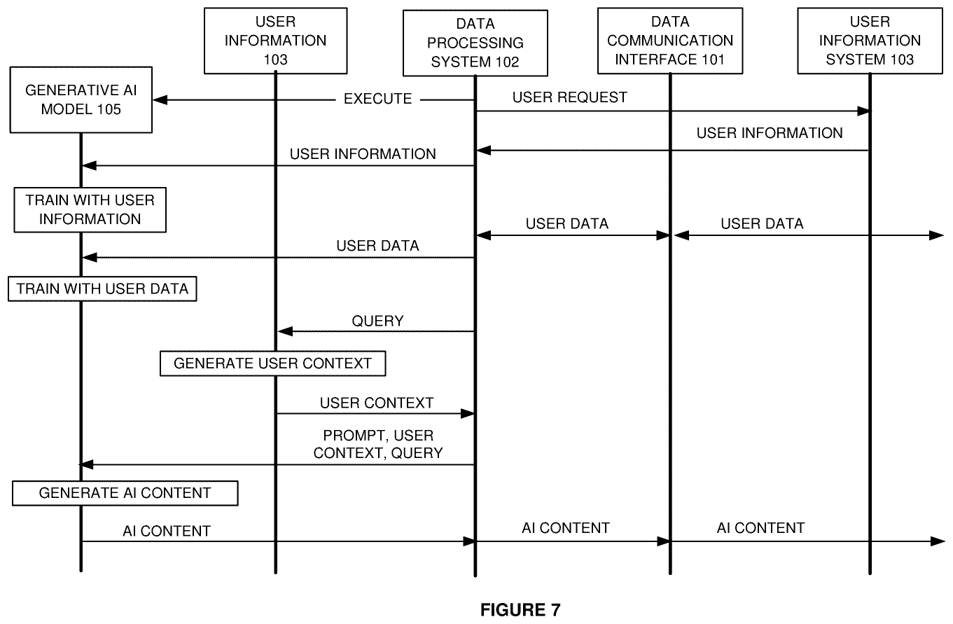

FIG. 7 illustrates the exemplary operation of user communication device 100 to generate the AI content for the user based on their user data communications by using the generative AI model 105 and user information system 103. The operation may differ in other examples. Data processing system 102 executes generative AI model 105. Data processing system 102 requests user information from user information system 103. User information system 103 transfers user information to data processing system 102. Data processing system 102 trains generative AI model 105 with the user information. For example, generative AL model 105 could be trained with user uplink/downlink throughput and latency in association with time, location, and user application.

Data processing system 102 exchanges user data over data communication interface 101. Data processing system 102 trains generative AI model 105 with the user data in response to the user data exchange. Private user data may be omitted from the training data. Data processing system 102 may train generative AI model 105 with other user information as well. For example, generative AI model 105 may be trained with favorite user device orientations for gaming and working. Data processing system 102 transfers a query to generative AI model 105. Generative AI model 105 processes the query to generate user context. Generative AI model 105 processes the prompt based on the user context to generate and transfer AI content to data processing system 102. The AI content is based on the user context. Data processing system 102 transfers the AI content over data communication interface 101. For example, the AI content may be an AI-generated vacation video that is based on user videos, images, songs, and locations but that is augmented by AI video generation and editing.

Advantageously, user communication device 100 personalizes AI content for its user by training AI models 104-105 with user data that was communicated by user communication device 100. AI models 104-105 generate user context that is combined with AI prompts to personalize the AI-generated content for the user.

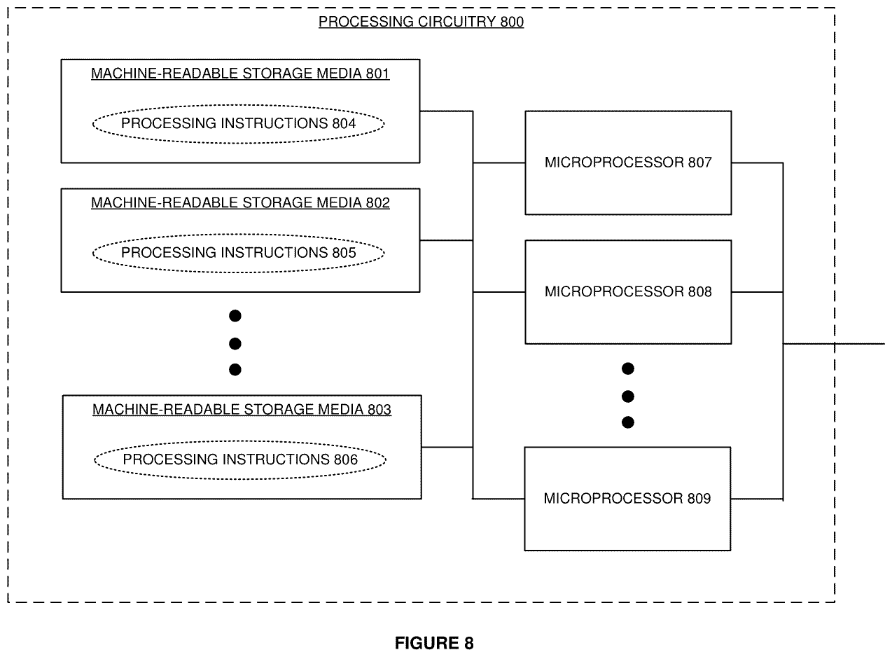

FIG. 8 illustrates exemplary processing circuitry 800 to generate AI content for a user based on their user data communications. Processing circuitry 800 comprises an example of user communication device 100, although device 100 may differ. Processing circuitry 800 comprises machine-readable storage media 801-803 and microprocessors 807-809 that are communicatively coupled. Machine-readable storage media 801-803 store processing instructions 804-806 in a non-transitory manner. Microprocessors 807-809 comprise DSPs, CPUs, GPUs, ASICs, and/or some other data processing hardware. Machine-readable storage media 801-803 comprises RAM, flash circuitry, disk drives, and/or some other type of data storage apparatus. Microprocessors 807-809 retrieve processing instructions 804-806 from non-transitory machine-readable storage media 801-803. Microprocessors 807-809 execute processing instructions 804-806 to generate AI content for a user based on their user data communications as described above for user communication device 100 and as described below for wireless User Equipment (UE) 900 and 1400. The amount of storage media, microprocessors, processing instructions that are shown in FIG. 8 may vary in other examples.

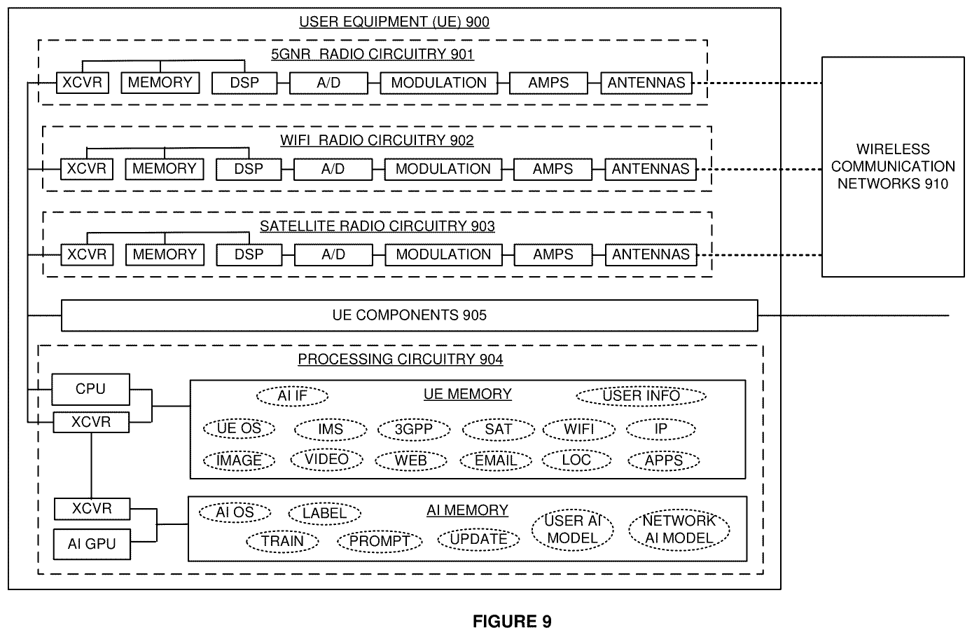

FIG. 9 illustrates exemplary wireless User Equipment (UE) 900 that generates AI content for a user based on their use of wireless UE 900. Wireless UE 900 comprises an example of user communication device 100 and processing circuitry 800, although device 100 and circuitry 800 may differ. Wireless UE 900 comprises Fifth Generation New Radio (5GNR) radio circuitry 901, Wireless Fidelity (WIFI) radio circuitry 902, satellite radio circuitry 903, processing circuitry 904, and user components 905. Radio circuitry 901-903 comprises antennas, amplifiers, filters, modulation, analog-to-digital interfaces, DSPs, memories, and transceivers (XCVRs) that are coupled over bus circuitry. Processing circuitry 904 comprises CPUs, GPUs, memories, and transceivers that are coupled over bus circuitry. UE components 905 comprise cameras, microphones, speakers, displays, personal area network interfaces, global positioning satellite (GPS) receiver, power supply, sensors, gyroscopes, and/or some other user apparatus.

The UE memory in processing circuitry 904 stores software like a UE Operating System (OS), Artificial Intelligence Interfaces (AI IF), Internet Protocol Multimedia Subsystem Applications (IMS), Third Generation Partnership Project Applications (3GPP), Wireless Fidelity Applications (WIFI), Satellite Communication Applications (SAT), Internet Protocol Applications (IP), Image Applications (IMAGE), Video Applications (VIDEO), Web Applications (WEB), E-mail Applications, Geographic Location Applications (LOC), User Information Applications (USER INFO), and other User Applications (APPS). The AI memory in processing circuitry 904 stores software like an AI Operating System (OS), Labeling Modules (LABEL), Training Modules (TRAIN), Query and Prompting Modules (PROMPT), Update Modules (UPDATE), user AI model, and network AI model.

The antennas in radio circuitry 901-903 exchange wireless signals with wireless communication networks 910. In some examples, UE components 905 exchange user data with other data communication systems. For example, Internet Protocol (IP) over Ethernet communication components may communicate over the internet. Transceivers in radio circuitry 901-903 are coupled to transceivers in processing circuitry 904. In processing circuitry 904, the CPUs retrieve the software from the UE memory and execute the software to direct the operation of UE 900 as described herein. In processing circuitry 904, the GPUs retrieve the software from the AI memory and execute the software to direct the operation of UE 900 as described herein. In some examples, the UE OS and the AI OS may be integrated together.

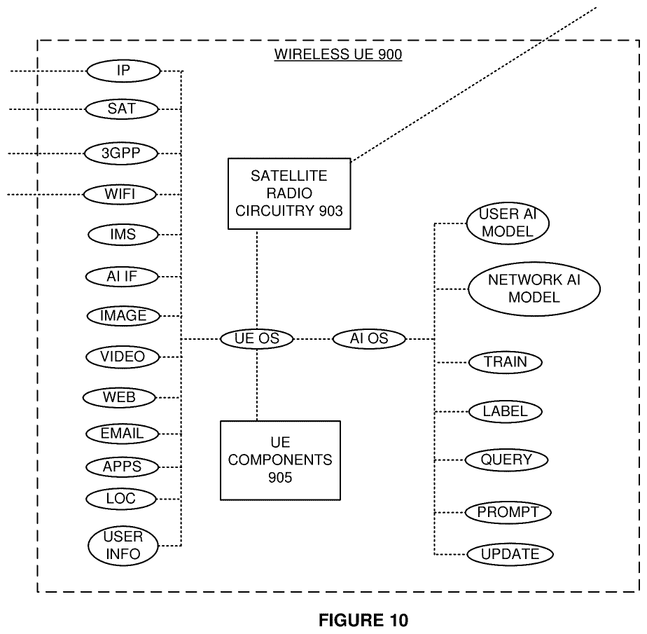

FIG. 10 illustrates an exemplary software architecture for wireless UE 900 that generates AI content for the user based on their use of wireless UE 900. The UE OS interacts with the AI OS, satellite radio circuitry 903, and UE components 905. The UE OS also interacts with its applications (IP, SAT, 3GPP, WIFI, IMS, AI IF, IMAGE, VIDEO, WEB, EMAIL, APPs, LOC, and USER INFO). The AI OS interacts with the UE OS, user AI model, network AI model. The AI OS also interacts with its applications (LABEL, TRAIN, PROMPT, and UPDATE). USER INFO collects user information like social networking information and location information from the UE OS. USER INFO transfers user information to TRAIN over the UE OS and the AI OS. TRAIN trains the user AI model and/or the network AI model with the user information. The UE OS exchanges user data over satellite radio circuitry 903. The UE OS trains transfers the user data to TRAIN over the AI OS. TRAIN trains the user AI model and/or the network AI model 105 with the user data in response to the satellite data exchange. TRAIN may train the AI models with other user information as well. LABEL may label some of the user data based on past user information and data. LABEL may prompt the user over the AI OS, UE OS, and UE components 905 to label some of the user data. For example, LABEL may not have a name for a frequent voice in video conferences, and might request the name of that person. LABEL may prompt the user to identify the user data that should not be used for training. For example, LABEL may request user approval for use of financial information. LABEL and/or TRAIN may remove the sensitive user data from the training data.

The user operates an application to generate and transfer an AI query and prompt over the UE OS to the AI OS. The AI OS interacts with QUERY and PROMPT to request AI content from the network AI model—possibly by using the user AI model. The network AI model generates the requested user content based on the query and prompt.

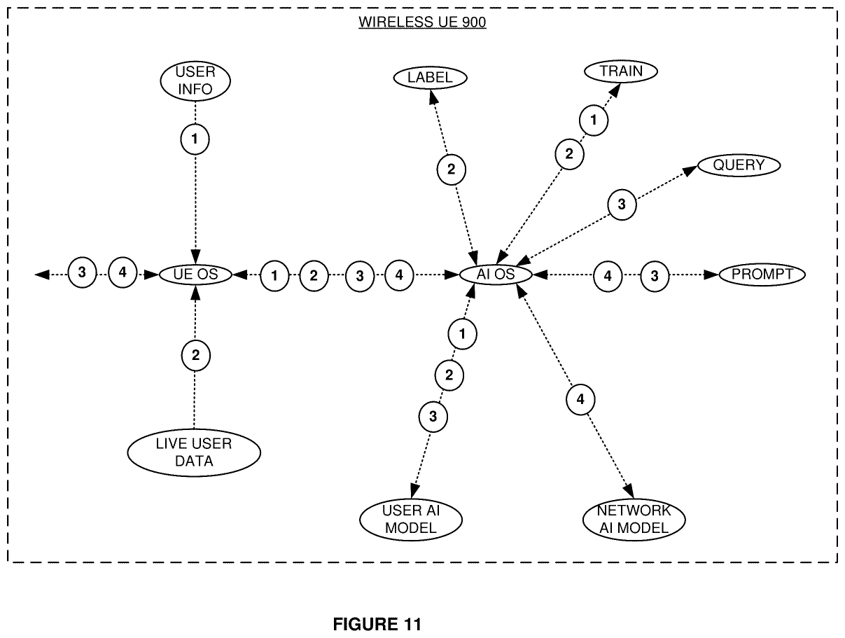

FIG. 11 illustrates an exemplary operation of wireless UE 900 to generate the AI content based on the use of wireless UE 900 by using the user AI model and the network AI model. The operation may differ in other examples. In a first operation (1), TRAIN obtains historical user information from USER INFO over the AI OS and UE OS and trains the user AI model with the historical user information. The historical user information may comprise past network performance/status, UE performance/status, locations, audios, videos, images, messaging, user applications, content-streaming, social networking, and/or some other user-related information. The user AI model is retrained with new historical information like recent places visited, photographs taken, and video games played.

In a second operation (2), LABEL obtains live user data communications from the UE OS over the AI OS. The live user data communications may indicate locations, audios, videos, images, messaging, user applications, content-streaming, social networking, and/or some other user-related information. LABEL labels the live user data and identifies (or removes) sensitive user data. LABEL may prompt the user or another application for labels over the AI OS and UE OS. LABEL transfers the labeled user data to TRAIN over the AI OS. TRAIN transfers the labeled user data to the user AI model. The user AI models trains with the labeled user data.

In a third operation (3), QUERY receives a user context query from an application or the user over the UE OS and AI OS. QUERY transfers the user context query to the user AI model over the AI OS. The user AI model processes the query to generate user context. For example, the user AI model may process a user ID to generate foods and restaurants liked by the user. The user AI model transfers the user context to QUERY over the AI OS, and QUERY transfers the user context and the query to PROMPT over the AI OS.

In a fourth operation (4), PROMPT receives a prompt from the application or the user over the UE OS and AI OS. PROMPT transfers prompt, user context, and query to the network AI model. The network AI model processes the prompt, user context, and query to generate AI content that is guided by the user context. For example, the network AI model may process the weight, activities, and favorites of the user to generate a meal plan that includes suitable restaurant meals.

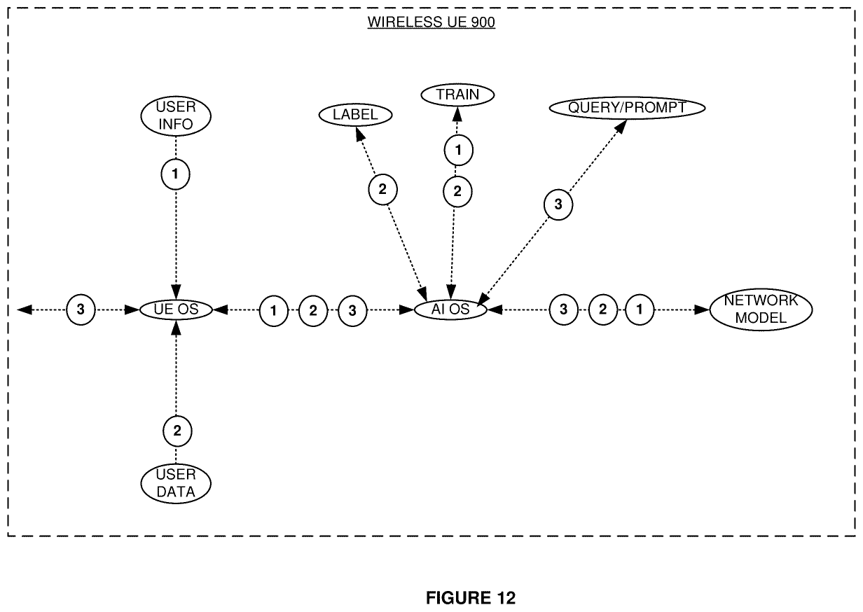

FIG. 12 illustrates an exemplary operation of wireless UE 900 to generate AI content for the user based on their use of the wireless UE 900 by using the network model. The operation may differ in other examples. In a first operation (1), TRAIN obtains historical user information from USER INFO over the AI OS and UE OS and trains the network AI model with the historical user information. The historical user information may comprise past network performance/status, UE performance/status, locations, audios, videos, images, messaging, user applications, content-streaming, social networking, and/or some other user-related information. The network AI model is subsequently retrained with new historical information like recent places visited, photographs taken, and video games played.

In a second operation (2), LABEL obtains live user data communications over the UE OS and the AI OS. The live user data communications may indicate locations, audios, videos, images, messaging, user applications, content-streaming, social networking, and/or some other user-related information. LABEL labels the live user data and identifies private user data. LABEL may prompt the user or another application for labels over the AI OS and UE OS—including the identification of private user data. LABEL transfers the labeled user data to TRAIN over the AI OS. TRAIN transfers the labeled user data to the network AI model. The network AI models trains with the labeled user data. LABEL and/or TRAIN may remove the private user data from the training data.

In a third operation (3), QUERY/PROMPT receives a user context query and an AI prompt from an application or the user over the UE OS and AI OS. QUERY/PROMPT transfers the prompt, user context, and query to the network AI model over the AI OS. The network AI model processes the prompt, user context, and query to generate AI content that is guided by the user context. For example, the network AI model may process the daily activities of the user to generate a work memo that describes daily work performance and tasks accomplished.

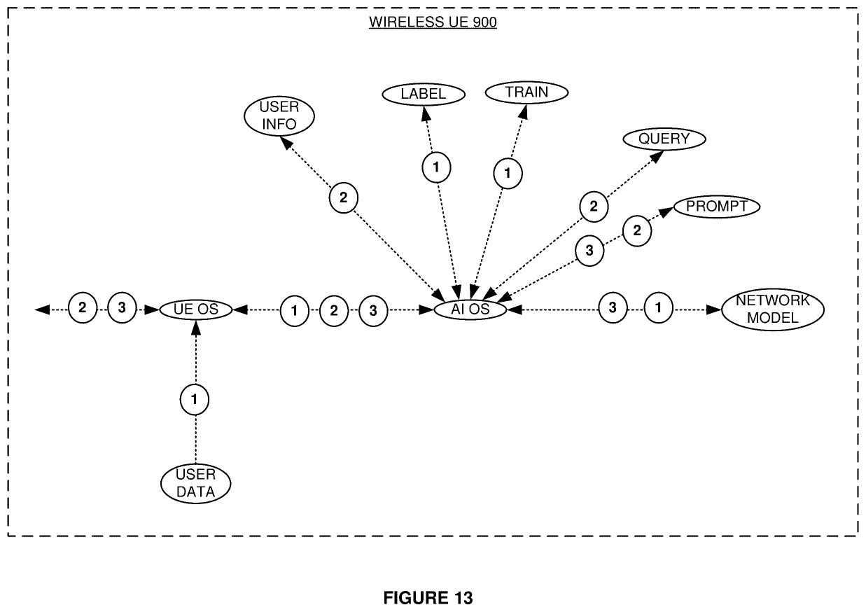

FIG. 13 illustrates an exemplary operation of wireless UE 900 to generate AI content for the user based on their use of wireless UE 900 by using the network model and the user information system. The operation may differ in other examples. In a first operation (1), LABEL obtains live user data communications from the UE OS over the AI OS. The live user data communications may indicate locations, audios, videos, images, messaging, user applications, content-streaming, social networking, and/or some other user-related information. LABEL labels the live user data and identifies private user data. LABEL may prompt the user or another application for labels over the AI OS and UE OS—including the identification of the private user data. LABEL transfers the labeled user data to TRAIN over the AI OS. TRAIN transfers the labeled user data to the user AI model. The user AI model trains with the labeled user data. LABEL and/or TRAIN may remove the private user data from the training data.

In a second operation (2), QUERY receives a user context query from an application or the user over the UE OS and AI OS. QUERY transfers the user context query to USER INFO over the AI OS. USER INFO processes the query to generate user context. For example, USER INFO may process a user ID to generate demographic information like age, occupation, location, health, hobbies, and the like for the user. USER INFO transfers the user context to QUERY over the AI OS, and QUERY transfers the user context and the query to PROMPT over the AI OS.

In a third operation (3), PROMPT receives a prompt from the application or the user over the UE OS and AI OS. PROMPT transfers the prompt, user context, and query to the network AI model. The network AI model processes the prompt, user context, and query to generate AI content that is guided by the user context.

Advantageously, wireless UE 900 personalizes AI content for its user by training AI models with user data that was wirelessly communicated by UE 900. The AI models generate user context that is combined with AI prompts to personalize AI-generated content for the user.

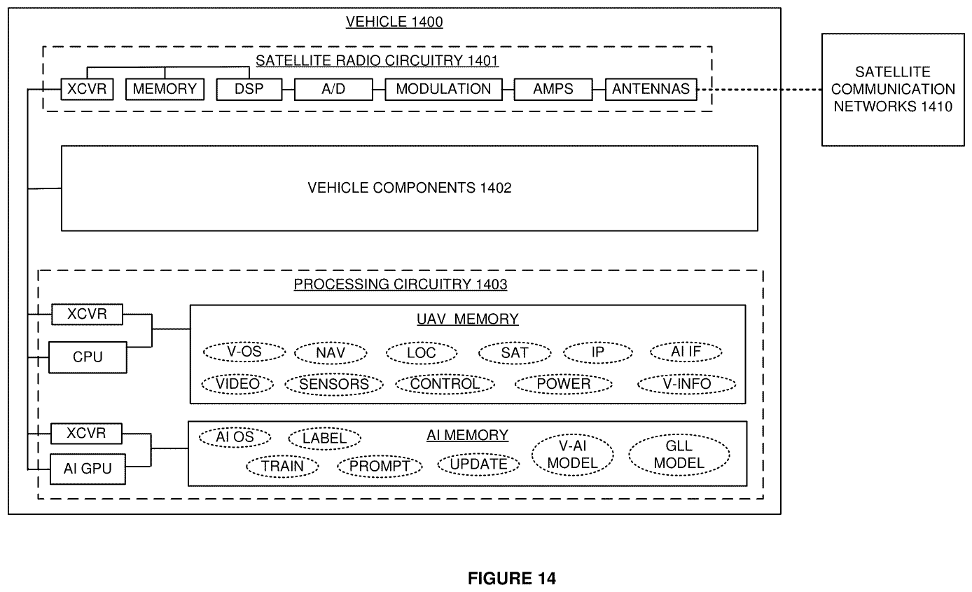

FIG. 14 illustrates exemplary vehicle 1400 that generates AI content based on vehicle data communications. Vehicle 1400 comprises an example of user communication device 100, processing circuitry 800, and UE 900, although device 100, circuitry 800, and UE 900 may differ. Vehicle 1400 comprises satellite radio circuitry 1401, vehicle components 1402, and processing circuitry 1403. Satellite radio circuitry 1401 comprises antennas, amplifiers, filters, modulation, analog-to-digital interfaces, DSPs, memories, and transceivers (XCVRs) that are coupled over bus circuitry. Vehicle components 1402 comprise cameras, motors, controllers, global positioning satellite (GPS) receiver, power supply, sensors, gyroscopes, and/or some other vehicle apparatus. Processing circuitry 1403 comprises CPUs, GPUs, memories, and transceivers that are coupled over bus circuitry. The vehicle memory in processing circuitry 1403 stores software like a Vehicle Operating System (V-OS), Navigation Applications (NAV), Location Applications (LOC), Satellite Communication Applications (SAT), Internet Protocol Applications (IP), Artificial Intelligence Interfaces (AI IF), Video Applications (VIDEO), Sensor Applications (SENSORS), Control Applications (CONTROL), Power Applications (POWER), Vehicle Information Applications (V-INFO). The AI memory in processing circuitry 1404 stores software like an AI Operating System (AI OS), Labeling Modules (LABEL), Training Modules (TRAIN), Query and Prompting Modules (PROMPT), Update Modules (UPDATE), Vehicle AI (V-AI) model, and Generative Large Language AI Model (GLL) model.

The antennas in radio circuitry 1401 exchange wireless signals with satellite communication networks 1410. Transceivers in radio circuitry 1401 are coupled to transceivers in processing circuitry 1403. In processing circuitry 1403, the CPUs retrieve the software from the vehicle memory and execute the software to direct the operation of vehicle 1400 as described herein for UE 900. In processing circuitry 903, the GPUs retrieve the software from the AI memory and execute the software to direct the operation of vehicle 1400 as described herein for user communication device 100, processing circuitry 800, and wireless UE 900. In some examples, the V-OS and the AI OS may be integrated together.

In operation, TRAIN obtains historical user information from V-INFO over the AI OS and UE OS and trains the V-AI model with the historical user information. The historical user information may comprise past network performance/status, UE performance/status, locations, videos, messaging, vehicle applications, maintenance, and/or some other vehicle-related information. The user AI model is retrained with new historical information like recent places visited, cargo taken, and maintenance performed. LABEL obtains live vehicle data communications from the UE OS over the AI OS. The live vehicle data communications may indicate locations, videos, messaging, weather, user applications, and/or some other vehicle-related information. LABEL labels the live vehicle data. LABEL may prompt another application for labels over the AI OS and UE OS. LABEL transfers the labeled user data to TRAIN over the AI OS. TRAIN transfers the labeled user data to the V-AI model. The V-AI model trains with the labeled user data. QUERY receives a vehicle context query from an application over the UE OS and AI OS. QUERY transfers the vehicle context query to the V-AI model over the AI OS. The V-AI model processes the query to generate vehicle context. For example, the V-AI model may process a user ID to generate prior cargos and locations for vehicle 1400. The V-AI model transfers the vehicle context to QUERY over the AI OS. QUERY transfers the vehicle context and the query to PROMPT over the AI OS. PROMPT receives a prompt from the application over the UE OS and AI OS. PROMPT transfers the prompt, vehicle context, and query to the GLL model. The GLL model processes the prompt, vehicle context, and query to generate AI content that is guided by the vehicle context. For example, the GLL AI model may process cargo and location data for vehicle 1400 to generate a maintenance plan for vehicle 1400.

The wireless communication system circuitry described above comprises computer hardware and software that form special-purpose data communication circuitry to generate AI content for the user based on their user data communications. The computer hardware comprises processing circuitry like CPUs, DSPs, GPUs, transceivers, bus circuitry, and memory. To form these computer hardware structures, semiconductors like silicon or germanium are positively and negatively doped to form transistors. The doping comprises ions like boron or phosphorus that are embedded within the semiconductor material. The transistors and other electronic structures like capacitors and resistors are arranged and metallically connected within the semiconductor to form devices like logic circuitry and storage registers. The logic circuitry and storage registers are arranged to form larger structures like control units, logic units, and Random-Access Memory (RAM). In turn, the control units, logic units, and RAM are metallically connected to form CPUs, DSPs, GPUs, transceivers, bus circuitry, and memory.

In the computer hardware, the control units drive data between the RAM and the logic units, and the logic units operate on the data. The control units also drive interactions with external memory like flash drives, disk drives, and the like. The computer hardware executes machine-level software to control and move data by driving machine-level inputs like voltages and currents to the control units, logic units, and RAM. The machine-level software is typically compiled from higher-level software programs. The higher-level software programs comprise operating systems, utilities, user applications, and the like. Both the higher-level software programs and their compiled machine-level software are stored in memory and retrieved for compilation and execution. On power-up, the computer hardware automatically executes physically-embedded machine-level software that drives the compilation and execution of the other computer software components which then assert control. Due to this automated execution, the presence of the higher-level software in memory physically changes the structure of the computer hardware machines into special-purpose data communication circuitry to generate AI content for the user based on their user data communications.

The included descriptions and figures depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the disclosure. Those skilled in the art will also appreciate that the features described above may be combined in various ways to form multiple embodiments. As a result, the invention is not limited to the specific embodiments described above, but only by the claims and their equivalents.

Although the descriptions provided herein may be in the context of certain radio access technologies, networks, and network topologies, such as 5G/NR mobile communications, the proposed concepts, schemes, and any variations thereof may be implemented in, for and by other types of radio access technologies, networks, and network topologies. Such radio access technologies, networks, and network topologies may include, for example and without limitation, Long-Term Evolution (LTE), Internet-of-Things (IoT), Narrow Band Internet of Things (NB-IoT), vehicle-to-everything (V2X), fixed wireless internet, and non-terrestrial network (NTN) communications. Thus, the scope of the disclosure is not limited to the examples described herein.

What is claimed is:

1. A method comprising:
exchanging user data with data communication equipment;
in response to exchanging the user data, training a user Artificial Intelligence (AI) model with the user data;
transferring a query to the user AI model, and in response, receiving user context from the user AI model; and
transferring a prompt that includes the user context to a generative AI model, and in response, receiving AI content from the generative AI model that is based on the user context.

2. The method of claim 1 further comprising:
prompting a user to label portions of the user data;
receiving the labels for the portions of the user data from the user; and wherein
training the user AI model with the user data comprises training the user AI model with the labeled user data.

3. The method of claim 1 further comprising:
prompting a user to label a recent portion of the user data in response to a past portion of the user data;
receiving the label for the recent portion of the user data from the user; and wherein
training the user AI model with the user data comprises training the user AI model with the labeled user data.

4. The method of claim 1 further comprising:
determining labels for portions of the user data; and wherein
training the user AI model with the user data comprises training the user AI model with the labeled user data.

5. The method of claim 1 further comprising:
determining a label for a recent portion of the user data based on a past portion of the user data; and wherein
training the user AI model with the user data comprises training the user AI model with the labeled user data.

6. The method of claim 1 further comprising receiving an update from the data communication equipment for the user AI model from the one or more data communication systems, and in response, updating the user AI model.

7. The method of claim 1 wherein exchanging the user data with the data communication equipment comprises wirelessly exchanging the user data with a wireless communication network.

8. The method of claim 1 wherein the user data comprises at least one of location data, audio data, video data, image data, user messaging data, user application data, content-streaming data, and social networking data.

9. The method of claim 1 wherein:
the user data comprises machine data that is used by a machine;
exchanging the user data comprises exchanging the machine data;
training the user AI model with the user data comprises training a machine AI model with the machine data;
transferring the query to the user AI model comprises transferring the query to the machine AI model;
receiving the user context from the user AI model comprises receiving machine context from the machine AI model;
transferring the prompt that includes the user context to the generative AI model comprises transferring the prompt that includes the machine context to the generative AI model; and
receiving the AI content from the generative AI model that is based on the user context comprises receiving machine content from the generative AI model that is based on the machine context.

10. A method comprising:
wirelessly exchanging user data with one or more wireless communication systems;
in response to wirelessly exchanging the user data, labeling the user data and training an Artificial Intelligence (AI) Large Language Model (LLM) with the labeled user data; and
transferring a prompt that includes a user query to the AI LLM, and in response, receiving AI content from the AI LLM, wherein the AI LLM processes the user query to generate user context and processes the prompt with the user context to generate the AI content.

11. The method of claim 10 wherein labeling the user data comprises prompting a user to label portions of the user data and receiving the labels for the portions of the user data from the user.

12. A wireless communication device comprising:
a data processing system to execute a user Artificial Intelligence (AI) model and a network AI model;
the data processing system to exchange user data with a wireless communication interface;
the wireless communication interface to wirelessly exchange the user data with a wireless communication network;
the data processing system to train the user AI model with the user data in response to exchanging the user data;
the data processing system to transfer a query to the user AI model, and in response, receive user context from the user AI model; and
the data processing system to transfer a prompt that includes the user context to the network AI model, and in response, receive AI content from the network AI model that is based on the user context.

13. The wireless communication device of claim 12 further comprising:
the data processing system to prompt a user to label portions of the user data and receive the labels for the portions of the user data from the user; and wherein
the data processing system is to train the user AI model with the labeled user data to train the user AI model with the user data.

14. The wireless communication device of claim 12 further comprising:
the data processing system to prompt a user a user to label a recent portion of the user data in response to a past portion of the user data and to receive the label for the recent portion of the user data from the user; and wherein
the data processing system is to train the user AI model with the labeled user data to train the user AI model with the user data.

15. The wireless communication device of claim 12 further comprising:
the data processing system to determine labels for portions of the user data; and wherein
the data processing system is to train the user AI model with the labeled user data to train the user AI model with the user data.

16. The wireless communication device of claim 12 further comprising:
the data processing system to determine a label for a recent portion of the user data based on a past portion of the user data; and wherein
the data processing system is to train the user AI model with the labeled user data to train the user AI model with the user data.

17. The wireless communication device of claim 12 further comprising:
the wireless communication interface to wirelessly receive updates for the user AI model and the network AI model from wireless communication network, and in response, update the user AI model and the network AI model.

18. The wireless communication device of claim 12 wherein the user data comprises at least one of location data, audio data, video data, image data, user messaging data, user application data, content-streaming data, and social networking data.

19. The wireless communication device of claim 12 wherein:
the user data comprises machine data that is used by a machine;
the user AI model that is trained with the user data comprises a machine AI model that is trained with the machine data;
the user context comprises machine context; and
the AI content comprises machine content that is based on the machine context.

20. The wireless communication device of claim 12 wherein:
the user data comprises vehicle data that is used by a vehicle;
the user AI model that is trained with the user data comprises a vehicle AI model that is trained with the vehicle data;
the user context comprises vehicle context; and
the AI content comprises vehicle content that is based on the vehicle context.
